(19) United States
(12) Patent Application Publication
(10) Pub. No.: US 2017/0273849 A1
(43) Pub. Date: Sep. 28, 2017

(54) ACTIVE RECORERY SYSTEM AND METHOD HAVING CAPACITIVE PROXIMITY SENSOR

(71) Applicant: Under Armour, Inc., Baltimore, MD (US)

(72) Inventors: Mark Oleson, Baltimore, MD (US); F. Grant Kovach, Baltimore, MD (US); Nathan Dau, Baltimore, MD (US); Angela Nelligan, Baltimore, MD (US)

(21) Appl. No.: 15/082,517

(22) Filed: Mar. 28, 2016

(51) Int. Cl. A61H 1/00

(52) U.S. Cl. CPC A61H 1/008; A61H 2209/00; A61H 2205/12; A61H 2201/5058

(57) ABSTRACT

A shoe has a sole having a capacitive sensor and a force actuating mechanism, and a wireless receiver. The capacitive sensor can detect and sense whether or not there is a foot is in the shoe. The force actuating mechanism can operate like a piston in an inactive mode (first position) and active mode (second position), wherein the active mode extends the force actuating mechanism's extending mechanism from first position to second position. The wireless receiver can retrieve any information in regards to geodetic locations from the capacitive sensor based on the capacitance signal.

### BACKGROUND

The present invention generally deals with systems and methods for operating a shoe to provide active foot recovery.

The human foot contains a venous pumping mechanism known as the plantar venous plexus, which works to help the heart pump blood. The plantar venous plexus is composed of multiple large-diameter veins that stretch the arch of the foot. The plantar venous plexus is a network of interconnected veins that facilitates returning blood from veins in the foot towards the heart, aiding blood flow in the lower limbs. The natural mechanism for pumping blood that pools at the bottom of the foot is through the compression of the plantar venous plexus, such as that which occurs during ambulation, and that is capable of significantly increase flow.

When a person lifts his foot off of the ground the plantar venous plexus is un-constricted and fills with blood from deep tissue veins in the foot. As the person puts his foot down and begins to apply pressure, the plantar venous plexus is constricted, which forces blood out of the foot and back towards the heart. This process is repeated as long as a person is performing an activity, which requires consistent use of the foot such as walking or running.

There have been several studies conducted on the physiology of venous foot pump and venous return for the foot for the recovery of people with a venous disease. Some of the studies have discovered that by getting some blood out of the feet, a better recovery can be generated. This reiterates on the natural mechanism as discussed above through ambulation, which humans naturally do. When walking, there is a force that pushes on the veins located at bottom of the foot (plantar venous plexus), which squishes/pumps blood up the leg. In other words, it is a one-way valve and with every step down, it keeps pumping blood up the leg.

The operation of the plantar venous plexus is limited when a person wears shoes. The sole of the shoe protects the bottom surface of a person's foot, but also inhibits the function of the plantar venous plexus. This inhibition leads to blood pooling in the foot, resulting in poor circulation. Poor circulation can lead to many health problems such as chronic pain, high blood pressure, or neuropathy. These problems may be magnified in athletes who endure long periods of physical exertion. Physical exertion requires blood to be pumped throughout the body much faster than normal, which results in an increased heartbeat. Extra strain may be applied to the heart during physical exertion due to the heart having to pump even harder, because the heart is not assisted by the plantar venous plexus.

There exists a need for a system and method to improve blood flow and speed recovery by pumping the venous plexus.

### BRIEF SUMMARY OF THE DRAWINGS

The accompanying drawings, which are incorporated in and form a part of the specification, illustrate an exemplary embodiment of the present invention and, together with the description, serve to explain the principles of the invention. In the drawings:

FIGS. 1A-B illustrate the plantar venous plexus, wherein FIG. 1A illustrates a bottom view of a foot, and FIG. 1B illustrates a side view of the foot;

FIG. 2 illustrates a shoe in accordance with aspects of the present invention;

FIGS. 3A-B illustrate a force actuating mechanism in retracted and extended states in accordance with aspects of the present invention;

FIG. 4A illustrates the state of a shoe with no foot therein in accordance with aspects of the present invention;

FIG. 4B illustrates a method of operating a device from a first position with a foot in the shoe in accordance with aspects of the present invention;

FIG. 4C illustrates a method of operating a device from a second position with a foot detected in the shoe in accordance with aspects of the present invention;

FIG. 5 illustrates an example of different geodetic locations in accordance with aspects of the present invention.

### DETAILED DESCRIPTION

### Overview

An aspect of the present invention is drawn to a shoe for use by user; where the shoe comprises a sole having a top surface for supporting the foot of the user when being worn the user; a force actuating mechanism operable to provide a force normal to the top surface of the sole, the force actuating mechanism being disposed at the sole so as to provide the force to a plantar venous plexus of the foot; a capacitive sensor operable to generate a capacitance signal based on one of the group consisting of a capacitance, a change in capacitance and a combination thereof; and a controller operable to generate a control signal, based on the capacitance signal, to control the force actuating mechanism.

Another aspect of the invention is drawn to a non-transitory, tangible, computer-readable media having computer-readable instructions stored thereon, the computer-readable instructions being capable of being read by a computer and being capable of instructing the computer to perform the method that comprises generating a capacitance signal via a capacitive sensor in a shoe comprising a sole, a force actuating mechanism, the capacitive sensor and a controller, the sole having a top surface for supporting the foot of the user when being worn by the user, the force actuating mechanism being operable to provide a force normal to the top surface of the sole, the force actuating mechanism being disposed at the sole so as to provide the force to a plantar venous plexus of the foot, the capacitance signal being based on one of the group consisting of a capacitance, a change in capacitance and a combination thereof; and generating, via the controller, a control signal based on the capacitance signal, to control the force actuating mechanism.

### Example Embodiments

In an example embodiment a user wears a shoe, which includes a sole that comprises a device to detect whether or not there is a foot in the shoe in order to perform active foot recovery. In another example embodiment, a user goes for a run with regular shoes. After the user completes the run and returns home, the user takes off the running shoes and puts on the active recovery shoes wherein there is an active recovery system in the shoes that applies a force to the bottom of the foot, more specifically the plantar venous plexus of the user to help pump pooled blood from the lower extremities, out towards the heart. A problem with wearing shoes over a long period of time is that they inhibit the operation of the plantar venous plexus, which causes blood pooling and circulation problems. Blood pooling and poor circulation can eventually lead to health problems. The purpose of the invention is to use a capacitive sensor inside the sole of the shoe to detect whether or not there is a foot in the shoe in order for the device inside of the sole of the shoe to perform active foot recovery by helping to pump pooled blood to enhance a better blood circulation.

Current studies, publications and prospective devices using electronics such as massive motor gear box, springs, controller buttons and batteries may require an end user to either plug a power supply into the device to charge the battery, or use a USB cord to activate the electronic device in case the battery dies. There is an inconvenience to the conventional ways that are known to enhance a better blood circulation of the foot through the venous plexus.

The system and method in accordance with aspects of the present invention includes an active recovery shoe that uses a capacitor proximity sensor to detect when a foot is in the shoe. Capacitor proximity sensors produce an electrostatic field instead of an electromagnetic field. Capacitor proximity sensors can detect any target that has a dielectric constant greater than air. The dielectric constant is an electrostatic field generated by the oscillator circuit and if an object enters the electrostatic field and causes interference oscillation then begins. The detector or trigger circuit monitors the oscillator's output and when it detects sufficient change in the field, it switches on the output circuit and the output circuit remains active until the target is removed from the sensing field.

In some embodiments, when the capacitor sensor detects that a foot is in the shoe, an active recovery device engages the plantar venous plexus. The act of pushing up into the plantar venous plexus is to pump the blood up and when the blood comes back, new blood comes back in and the process continues, which aids recovery.

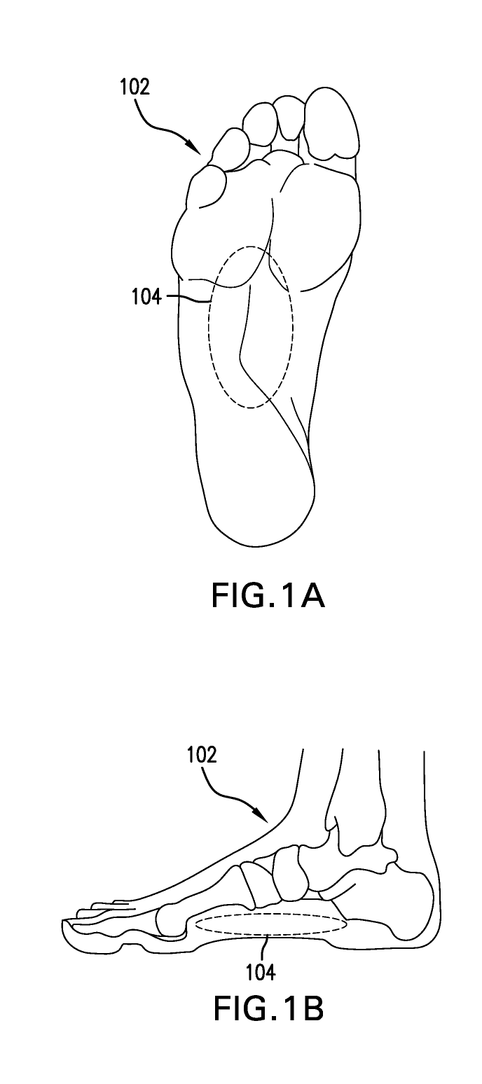

Example embodiments in accordance with aspects of the present invention will now be described with reference to FIGS. 1A-5.

FIGS. 1A-B illustrate the plantar venous plexus. FIG. 1A illustrates a bottom view of a foot 102, whereas FIG. 1B illustrates a side view of foot 102.

As shown in the figures, plantar venous plexus 104 is generally located in the central portion of the plantar side of foot 102.

Plantar venous plexus 104 is an area of foot 102 that functions to pump blood back up the leg from the foot and is also known as the venous foot pump. Typically, plantar venous plexus 104 is directly involved with the action of walking, with the pressures exerted on the foot during the walking cycle serving to effectively pump the blood. The purpose is to pump deoxygenated blood up the leg to the next stage pump, called the calf pump. The pumping action serves to take blood that has delivered nutrients to the foot and move the blood back toward the heart and lungs, taking all the waste products with it.

Problems may arise, though, after a person has a strenuous workout and desires to rest and recover. While the person is resting, plantar venous plexus 104 is not effectively pumping blood and disposing of waste products, instead allowing the waste products to pool in the foot and lower leg. There exists a need for a device and method to effectively pump blood through the plantar venous plexus and support recovery after engaging in athletic activity.

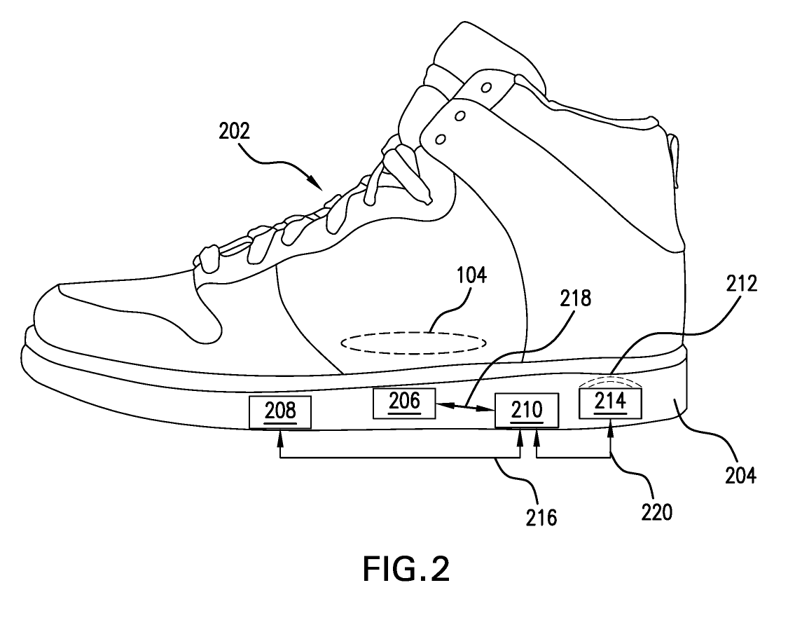

FIG. 2 illustrates a shoe in accordance with aspects of the present invention.

As shown in the figure, shoe 202 includes a sole 204, a force actuating mechanism 206, a communication component 208, a controller 210 and a capacitive sensor 214. Sole 204 further includes a top surface 212. Shoe 202 additionally includes a communication channel 216, a communication channel 218 and a communication channel 220.

Communication component 208 receives communications and sends those communications to controller 210.

Controller 210 receives communications from communication component 208 via communication channel 216, and provides instructions to force actuating mechanism 206 via communication channel 218. The instructions are based on the communications from communication component 208.

Force actuating mechanism 206 receives instructions from controller 210 via communication channel 218 and executes those instructions, resulting in force actuating mechanism 206 extending or retracting. Force actuating mechanism 206 is in contact with top surface of sole 212. As force actuating mechanism 206 extends, it exerts a force on plantar venous plexus 104 and as force actuating mechanism 206 retracts, it releases the force exerted on plantar venous plexus 104. Force actuating mechanism 206 can be any type of known actuator that can extend or retract, including, but not limited to, hydraulic, pneumatic, electric, thermal, magnetic, mechanical and combinations thereof.

Capacitive sensor 214 provides signals to controller 210 via communication channel 220.

Communication channels 216, 218 and 220 may be any known type of communication channel that enable transfer of information. Non-limiting examples of types of communication channels include wired and wireless.

As shown in the figure, force actuating mechanism 206, communication component 208 and controller 210 are shown as separate components. However, in some embodiments, at least two of force actuating mechanism 206, communication component 208 and controller 210 may be combined as a single device.

In some other embodiments, at least one of communication component 208 and controller 210 may be implemented as a computer having tangible computer-readable media for carrying or having computer-executable instructions or data structures stored thereon. Such tangible computer-readable media can be any available media that can be accessed by a general purpose or special purpose computer. Non-limiting examples of tangible computer-readable media include physical storage and/or memory media such as RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. For information transferred or provided over a network or another communications connection (either hardwired, wireless, or a combination of hardwired or wireless) to a computer, the computer may properly view the connection as a computer-readable medium. Thus, any such connection may be properly termed a computer-readable medium. Combinations of the above should also be included within the scope of computer-readable media.

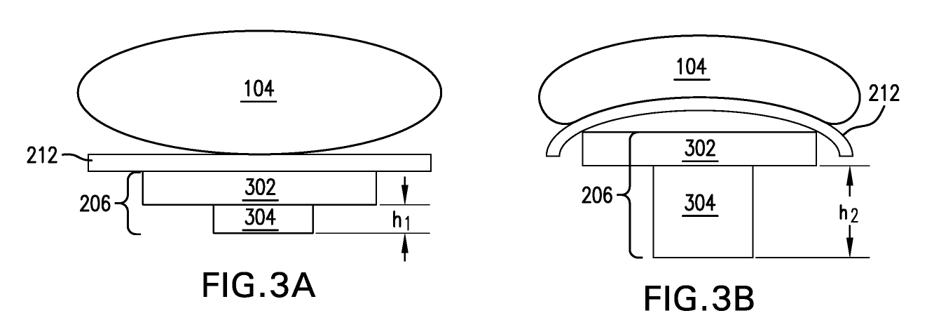

FIGS. 3A-B illustrate force actuating mechanism 206 in retracted and extended states in accordance with aspects of the present invention.

As shown in the figures, force actuating mechanism 206 includes a surface portion 302 and an extending mechanism 304. Surface portion 302 is in contact with both extending mechanism 304 and top surface of sole 212.

As shown in FIG. 3A, force actuating mechanism 206 is in a retracted state, with the height of extending mechanism 304 denoted by height h₁. In this configuration, surface portion 302 is not pushing against sole 212 and sole 212 is not pushing against the foot of the wearer. With extending mechanism 304 not pushing against the foot of the wearer, plantar venous plexus 104 is not compressed, so force actuating mechanism 206 is not acting to pump blood through plantar venous plexus 104.

As shown in FIG. 3B, force actuating mechanism 206 is in an extended state, with the height of extending mechanism 304 denoted by height h₂. In this configuration, surface portion 302 is pushing against top surface 212, and top surface 212 is pushing against the bottom of the foot of the wearer. With extending mechanism 304 pushing against the foot of the wearer, plantar venous plexus 104 is compressed, so force actuating mechanism 206 is acting to pump blood through plantar venous plexus 104.

In operation, force actuating mechanism 206 cycles between the retracted state as shown in FIG. 3A to the extended state as shown in FIG. 3B, thus cyclically pumping plantar venous plexus 104.

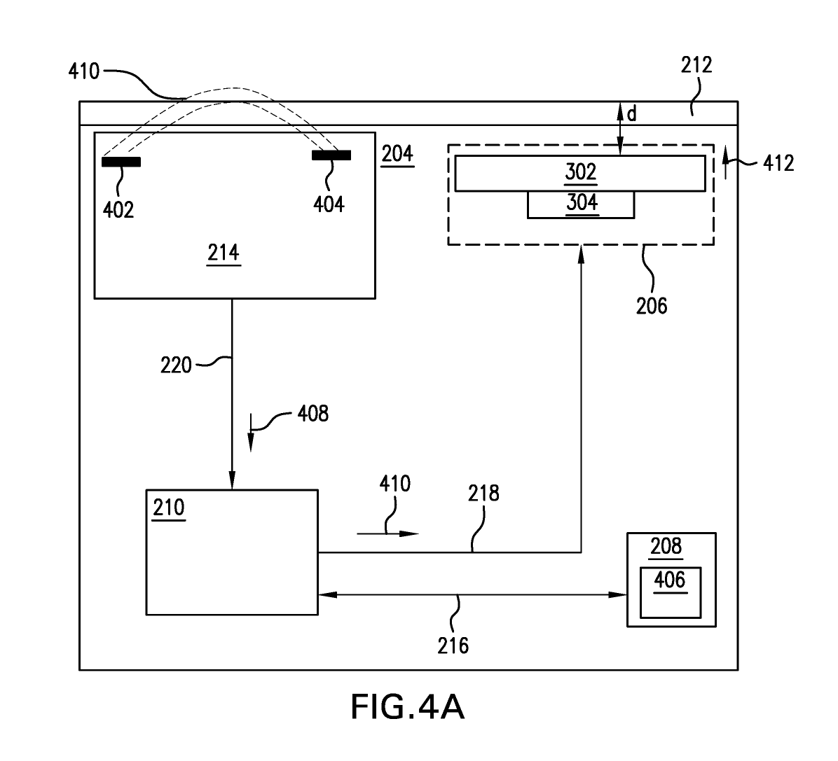

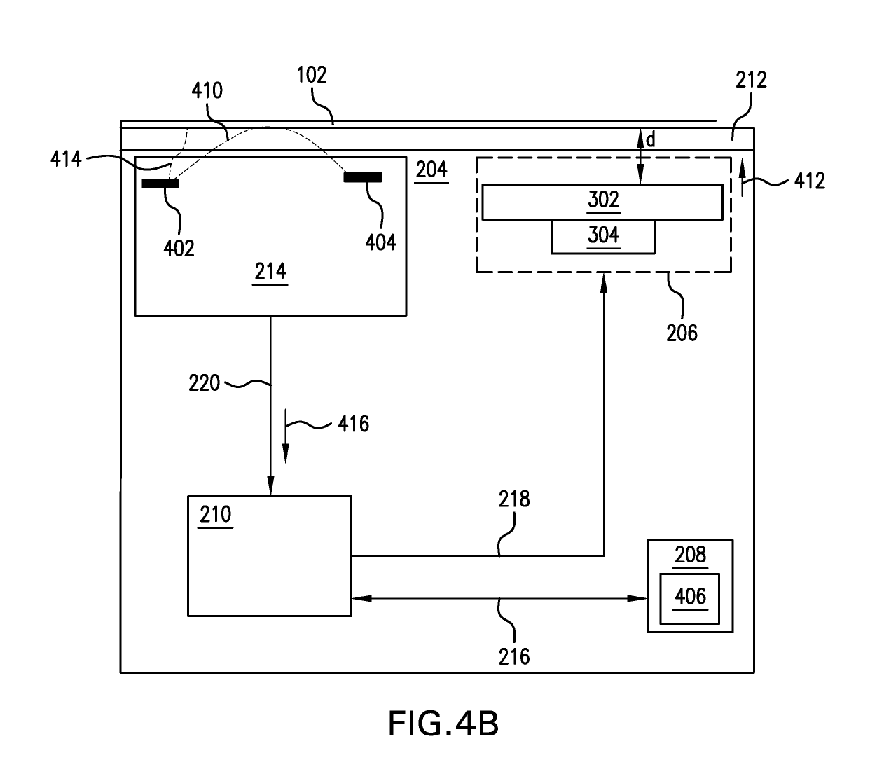

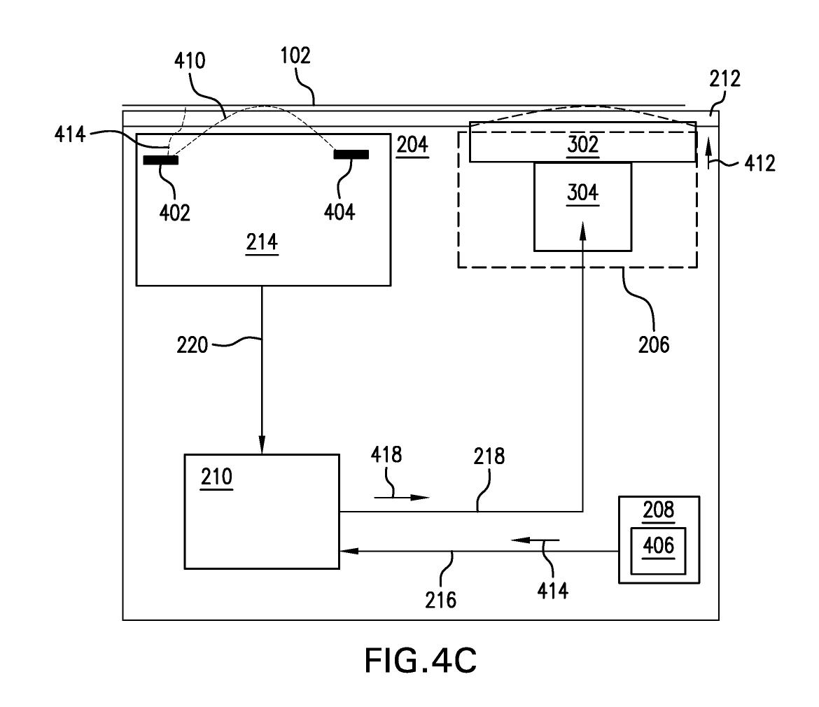

States of shoe 202 with and without a foot therein, will now be described in greater detail with reference to FIGS. 4A-C.

FIG. 4A illustrates the state of shoe 202 with no foot therein in accordance with aspects of the present invention. The figure includes top surface 212 of sole 204, capacitive sensor 214, controller 210, force actuating mechanism 206 and communication component 208. In this example embodiment, capacitive sensor 214 includes an electrode 402 and an electrode 404. Communication component 208 includes a memory 406.

Capacitive sensor 214 may be any system or device able to generate a signal based on a detected capacitance or a detected change in capacitance. Electrode 402 and 404 are arranged in the same plane so as to generate an electric field 410 that starts at electrode 402, extends up through top surface 212 and then returns to electrode 404.

Memory 406 is operable to store a list of geodetic locations in which active foot recovery should be performed. This list of geodetic locations may be stored in memory 406 by any known manner.

As shown in FIG. 4A, capacitive sensor 214 is in communication with controller 210, via communication channel 220. Controller 210 is in communication with communication component 208, communication channel 216. Furthermore, controller 210 is also is communication with force actuating mechanism 206, via communication channel 218.

In FIG. 4A, foot 102 is not in shoe 202. Capacitive sensor 214 generates a capacitance signal 408 based on electric field 410. Capacitive sensor 214 sends capacitance signal 408 to controller 210.

In some embodiments capacitance signal 408 is generated based on a capacitance, a change in capacitance, or a combination thereof; if there is a certain threshold of capacitance it may be determined that the foot is in the shoe. Furthermore if there is a certain change in capacitance, it may also be determined that there is no foot in the shoe.

The information sent to controller 210 is then sent to communication component 208 wherein memory 406 compares information about user's location to the designated locations stored in memory 406 by the user. The user is able to store or input a preference list of locations in memory 406 wherein the locations stored in memory 406 are locations that the user has designated as appropriate places to perform active foot recovery

In some embodiment, if the user has not designated a certain location as an appropriate location to perform active foot recovery and as such, that location is not stored by memory 406, therefore, controller 210 will then send a control signal to activate force actuating mechanism 206. In some other embodiment, if the user has designated a certain location as an appropriate location to perform active foot recovery and as such, that location is stored by memory 406, therefore, controller 210 will send a control signal to deactivate force actuating mechanism 206. In a further embodiment where there is no foot in the shoe, controller 210 sends a control signal 410, to deactivate force actuating mechanism 206 or in this figure since there is no activity yet, to stay in its current state. Control signal 410 is based on capacitance signal 408.

Force actuating mechanism 206 includes surface portion 302 and extending mechanism 304, wherein extending mechanism 304 stays at its first position and a force 412 is the regular normal force of the ground pushing against the shoe as the user wears the shoe. In some embodiments extending mechanism 304 extends to a second position; this will be described in greater detail with reference to FIG. 4B-C.

FIG. 4B illustrates the state of shoe 202, once shoe 202 is put on a foot.

As shown in the figure, FIG. 4B is as similar as FIG. 4A, but shows foot 102 in shoe 202. Further, electric field 410 is modified such that field lines 414 couple with foot 102.

When field lines 414 couple with foot 102, electric field 410 between electrode 402 and electrode 404 decreases. This decrease in the electric field decreases the capacitance between electrodes 402 and 404.

Capacitive sensor 214 then provides a capacitance signal 416 to controller 210. Capacitance signal 416, which corresponds to the new capacitance associated with electric field 410 and field lines 414, indicates that foot 102 is in shoe 202.

FIG. 4C illustrates the state of shoe 202, after controller 210 has received capacitance signal 416, indicating that foot 102 is in shoe 202.

As shown in FIG. 4C, after controller 210 receives capacitance signal 416 (as shown in FIG. 4B), controller provides a control signal 418 to force actuating mechanism 206. Control signal 418 controls force actuating mechanism 206 to engage in active recovery in a manner discussed above with reference to FIGS. 1-3B.

In some embodiments capacitance signal 416 is based on a specific capacitance. For example, capacitance signal 416 may be based on a capacitance value as determined by capacitive sensor 214. Further, controller 210 may compare the value of capacitance signal 416 with a priori capacitance values that are indicative of a foot being in shoe 202.

In some embodiments capacitance signal 416 is based on a change in capacitance. For example, capacitance signal 416 may be based on the difference, Δ_{C}, between a first capacitance value as determined by capacitive sensor 214 at a first time and a second capacitance value as determined by capacitive sensor 214 at a second time. Δ_{C} being larger than a predetermined threshold may be indicative of a foot being in shoe 202, wherein capacitive sensor 214 would generate capacitance signal 416. In these embodiments, controller 210 would generate control signal 418 upon receiving capacitance signal 416, without a need to compare the value of capacitance signal 416 with a priori capacitance values that are indicative of a foot being in shoe 202.

One aspect of the present invention, as discussed with reference to FIGS. 4A-C is drawn to detecting when foot 102 is in shoe 202 by way of a capacitive sensor in order to engage in active foot recovery. It should be noted that other foot-presence detecting systems may be used. For example, pressure or inductance sensors may be used to detect presence of foot in shoe 202.

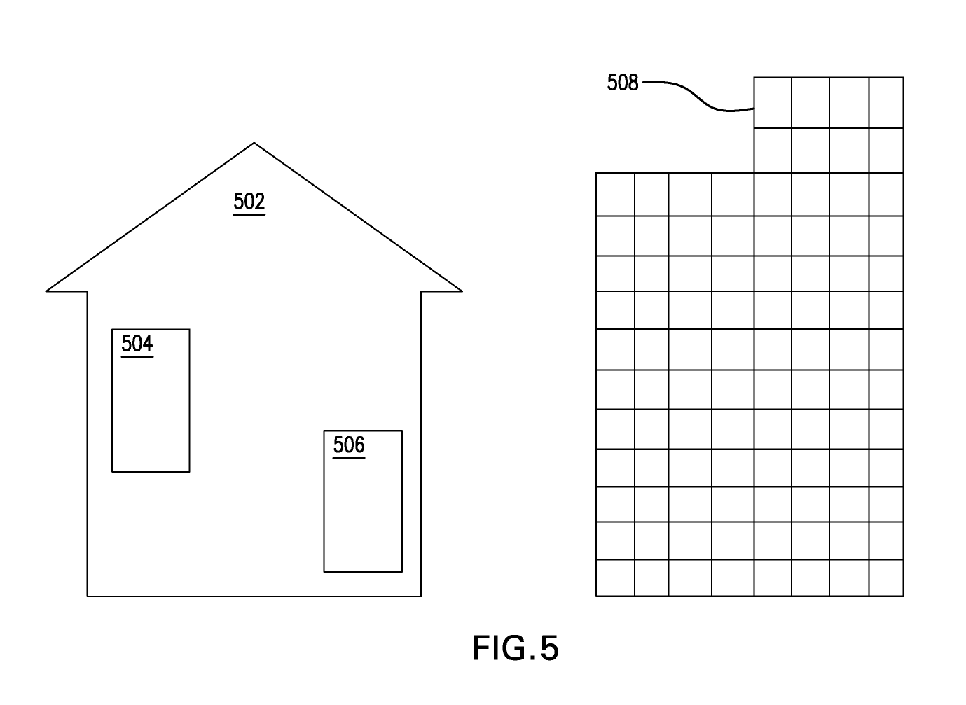

In any event, another aspect of the present invention is drawn to location-based activation of active foot recovery. This will additionally be described with reference to FIGS. 4-5.

FIG. 5 illustrates an example of different geodetic locations in which a person might wear shoe 202.

FIG. 5 includes a house 502 and an office building 508, which are located at different geodetic locations. House 502 includes a bedroom 504 and a living room 506, which are in different geodetic locations within house 502.

Returning to FIG. 4C, controller 210 is able to generate a location signal based on information obtained from communication component 208 and memory 406. When communication component 208 receives a wireless signal that includes the current location of a user wearing shoe 202, controller 210 takes the current location of the user and compares it to a list of locations stored in memory 406. The locations stored in memory 406 are locations that have been designated as places to perform active foot recovery.

If controller 210 finds that the current location of the user is stored in memory 406, it will determine that shoe 202 is in a location in which active foot recovery should be performed. If controller 210 finds that the current location of the user is not stored in memory 406, it will determine that shoe 202 is not in a location in which active foot recovery should be performed.

In some embodiments, if the user has not designated a certain location as an appropriate location to perform active foot recovery and as such, that location is not stored by memory 406, controller 210 will then send a control signal to deactivate force actuating mechanism 206. In some other embodiments, if the user has designated a certain location as an appropriate location to perform active foot recovery and as such, that location is stored by memory 406, controller 210 will send a control signal to activate force actuating mechanism 206. In a further embodiment, wherein there is a foot in shoe 202, controller 210 sends a control signal 420, to activate force actuating mechanism 206. Therefore, control signal 420 is based on capacitance signal 418 and a location signal.

When force actuating mechanism 206 is activated, extending mechanism 304 extends from its first position h₁ at normal state, as shown in FIG. 3A, to a second position h₂ as shown in FIG. 3B. At position h₂, top surface 212 of sole 204 pushes up into plantar venous plexus 104 for a better return of blood, alleviating pain.

As mentioned previously, in accordance with another aspect of the present invention, active recovery may be engaged when shoe 202 is at a predetermined location. This will be further described with reference to FIG. 5.

FIG. 5 illustrates a house 502 and an office building 508 at different geodetic locations. House 502 includes a bedroom 504 and a living room 506, which are in still different geodetic locations within house 502.

For purposes of discussion, let the location of office building 508 be a location that is not designated as being appropriate to perform active foot recovery. Further, let the location of living room 504 also be a location that is not designated as being appropriate to perform active foot recovery. Still further, let the location of bedroom 506 be a location that is designated as being appropriate to perform active foot recovery. Finally, let the locations of office building 508, bedroom 506 and living room 504 be stored in memory 406. These locations may be stored in any known manner, non-limiting examples of which include downloading or inputting via a user interface (not shown).

Now, let foot 102 be in shoe 202, while the user is in bedroom 504 Capacitive sensor 214 sends information to controller 210, and then controller 210 sends information received from capacitive sensor 214 to communication component 208 wherein memory 406 compares information about user's location to the designated locations stored in memory 406 by the user. The location of bedroom 504 exists in memory 406. Therefore controller 210 sends a control signal to activate force actuating mechanism 206.

Alternatively, if the user is at office building 508, controller 210 sends a control signal so as not to activate force actuating mechanism 206.

In other words, in some embodiments, in an a previously determined location for appropriate active foot recovery, shoe 202 will perform active foot recovery as discussed above with reference to FIG. 4C. Otherwise, in such embodiments, shoe 202 will not perform active foot recovery.

There are active recovery shoes that exist but the problem is the inefficiency of the functionalities. Some inefficiencies include massive motor gear box, springs, controller buttons and batteries may require an end user to either plug a power supply into the device to charge the battery, or use of USB cord to activate the electronic device in case the battery dies. The present invention uses a capacitive sensor inside the sole of the shoe to detect whether or not there is a foot in the shoe in order for the device inside of the sole of the shoe to automatically perform active foot recovery, that way there will not be any other way to turn on the device. Another aspect of the invention is the detection of the foot as well as the location of the user wherein the shoe may or may not operate based on the designated locations stored in the memory by the user on where and where not the shoe can operate.

What is claimed as new and desired to be protected by Letters Patent of the United States is:

1. A shoe for use by a user, said shoe comprising:
a sole having a top surface for supporting the foot of the user when being worn by the user;
a force actuating mechanism operable to provide a force normal to said top surface of said sole, said force actuating mechanism being disposed at said sole so as to provide the force to a plantar venous plexus of the foot;
a capacitive sensor operable to generate a capacitance signal based on one of the group consisting of a capacitance, a change in capacitance and a combination thereof; and
a controller operable to generate a control signal, based on the capacitance signal, to control said force actuating mechanism.

2. The shoe of claim 1,
wherein said force actuating mechanism comprises a surface portion and an extending mechanism,
wherein said extending mechanism is operable to extend said surface portion from a first position to a second position, and
wherein the second position is separated from the first position by a distance and in a direction normal to said top surface of said sole.

3. The device of claim 2,
wherein said capacitive sensor is operable to generate the capacitance signal based on a predetermined capacitance, and
wherein said controller is operable to generate the control signal to activate said force actuating mechanism.

4. The device of claim 2,
wherein said capacitive sensor is operable to generate the capacitance signal based on a predetermined change in capacitance, and
wherein said controller is operable to generate the control signal to activate said force actuating mechanism.

5. The device of claim 4,
wherein said capacitive sensor is further operable to generate a second capacitance signal based on a second predetermined change in capacitance, and
wherein said controller is operable to generate a second control signal to deactivate said force actuating mechanism.

6. The device of claim 1, further comprising:
a location determining circuit operable to generate a location signal based on a geodetic location of said shoe,
wherein said controller is operable to generate the control signal additionally based on the location signal.

7. The device of claim 6, wherein said location determining circuit comprises a wireless receiver.

8. The device of claim 7, wherein said wireless receiver is operable to receive a wireless signal as one of the group consisting of a global positioning system signal, a Wi-Fi signal and a cellular signal.

9. The device of claim 6, further comprising:
a memory having geodetic location information stored therein,
wherein said controller operable to generate the control signal additionally based on the geodetic location information.

10. A non-transitory, tangible, computer-readable media having computer-readable instructions stored thereon, the computer-readable instructions being capable of being read by a computer and being capable of instructing the computer to perform the method comprising:
generating a capacitance signal via a capacitive sensor in a shoe comprising a sole, a force actuating mechanism, the capacitive sensor and a controller, the sole having a top surface for supporting the foot of the user when being worn by the user, the force actuating mechanism being operable to provide a force normal to the top surface of the sole, the force actuating mechanism being disposed at the sole so as to provide the force to a plantar venous plexus of the foot, the capacitance signal being based on one of the group consisting of a capacitance, a change in capacitance and a combination thereof; and
generating, via the controller, a control signal based on the capacitance signal, to control the force actuating mechanism.

11. The non-transitory, tangible, computer-readable media of claim 10, the computer-readable instructions being capable of being read by a computer and being capable of instructing the computer to perform the method,
wherein the force actuating mechanism comprises a surface portion and an extending mechanism,
wherein the extending mechanism is operable to extend the surface portion from a first position to a second position,
wherein the second position is separated from the first position by a distance and in a direction normal to the top surface of the sole, and
wherein said generating a capacitance signal comprises generating the capacitance signal based on a predetermined capacitance, and
wherein said generating a control signal comprises generating the control signal to activate the force actuating mechanism.

12. The non-transitory, tangible, computer-readable media of claim 10, the computer-readable instructions being capable of being read by a computer and being capable of instructing the computer to perform the method,
wherein the force actuating mechanism comprises a surface portion and an extending mechanism,
wherein the extending mechanism is operable to extend the surface portion from a first position to a second position,
wherein the second position is separated from the first position by a distance and in a direction normal to the top surface of the sole, and
wherein said generating a capacitance signal comprises generating the capacitance signal based on a predetermined change in capacitance, and
wherein said generating a control signal comprises generating the control signal to activate the force actuating mechanism.

13. The non-transitory, tangible, computer-readable media of claim 12, the computer-readable instructions being capable of being read by a computer and being capable of instructing the computer to perform the method further comprising:
generating, via the capacitive sensor, a second capacitance signal based on a second predetermined change in capacitance; and
generating, via the controller, a second control signal to deactivate the force actuating mechanism.

14. The non-transitory, tangible, computer-readable media of claim 10, wherein the computer-readable instructions are capable of instructing the computer and being capable of instructing the computer to perform the method further comprising:
generating, via a location determining circuit, a location signal based on a geodetic location of the shoe,
wherein said generating a control signal comprises generating the control signal additionally based on the location signal.

15. The non-transitory, tangible, computer-readable media of claim 14, wherein the computer-readable instructions are capable of instructing the computer to perform the method such that said generating a location signal comprises generating the location signal via a wireless receiver.

16. The non-transitory, tangible, computer-readable media of claim 15, the computer-readable instructions being capable of being read by a computer and being capable of instructing the computer to perform the method such that said generating the location signal via a wireless receiver comprises generating the location signal via the wireless receiver that is operable to receive a wireless signal as one of the group consisting of a global positioning system signal, a Wi-Fi signal and a cellular signal.

17. The non-transitory, tangible, computer-readable media of claim 14, the computer-readable instructions being capable of being read by a computer and being capable of instructing the computer to perform the method further comprising:
storing geodetic location information into a memory,
wherein said generating a control signal comprises generating the control signal additionally based on the geodetic location information.
